(19) United States
(12) Patent Application Publication
(10) Pub. No.: US 2011/0310608 A1
(43) Pub. Date: Dec. 22, 2011

(54) LED LIGHT SOURCE

(75) Inventors: Walter P. Lapatovich, Boxford, MA (US); David W. Hamby, Andover, MA (US); William D. Koenigsberg, Concord, MA (US); Adam M. Scotch, Amesbury, MA (US)

(73) Assignee: OSRAM SYLVANIA INC., Danvers, MA (US)

(21) Appl. No.: 12/818,864

(22) Filed: Jun. 18, 2010

(51) Int. Cl. F21S 4/00; F21V 29/00

(52) U.S. Cl. 362/249.02; 362/294

(57) ABSTRACT

A lamp (10) has a concave reflector (12) that includes an opening (14) in the bottom thereof and is substantially symmetrically arrayed about a longitudinal axis (16). A light source (18) is positioned in the opening (14) and has a symmetry axis (19) that is coaxial with the longitudinal axis (16) of the reflector (12). The light source (18) comprises a hollow ceramic member (20) with an inner surface (22) and an outer surface (24). First and second electrically conductive traces (26, 28) and first and second rows (29, 31) of first and second electrically conductive pads (30, 32) connected by the electrically conductive traces (26, 28) are formed on the outer surface (24). Light emitting diodes (34) are associated with at least some of the electrically conductive pads (30, 32); and a heat-conducting mechanism (36) is contained within the hollow ceramic member (20) for removing heat generated by the light emitting diodes (34) when the light emitting diodes (34) are operating.

### TECHNICAL FIELD

This invention relates to lamps and to light sources therefor. Still more particularly it relates to such lamps and light sources employing light emitting diodes (LED or LEDs)

### BACKGROUND ART

The need for a replacement for the notoriously energy-inefficient incandescent lamp, which has been the mainstay of modern society for the last 100 years or so, has instilled in the industry a reason to provide a replacement. This need has been emphasized in the recent past by the tendency of many governments to actually ban such inefficient incandescent lamps in the very near future (by 2014, in some instances). A seemingly ready contributor for such replacement has been the use of light emitting diodes: however, while the efficacy of LEDs has improved greatly over the last few years, the higher cost of these light sources, when employed to provide equivalent light to the incandescent sources, has prevented their use as a general replacement for incandescent lamps. Also, while the LEDs do operate at temperatures far less than a comparable incandescent source, they do exhibit a rapid decrease in lumen output as their temperature increases and, when they are driven to their maximum output, their temperature does increase rapidly. Therefore, it has been necessary to provide complex structures to remove the generated heat for the LEDs to perform adequately. These structures have added to the cost of LED light sources and the lamps employing them and have restricted their acceptance into the general lighting field.

### SUMMARY OF INVENTION

It is, therefore, an object of the invention to obviate the above enumerated disadvantages of the prior art.

It is another object of the invention to enhance lamps and light sources therefor.

Yet another object of the invention is the improvement of lamps and light sources.

Still another object of the invention is the provision of a lamp employing LEDs as the light source, with such lamps being economically viable and providing simple and inexpensive ways of reducing light-loss due to extraneous heat.

These objects are accomplished, in one aspect of the invention, by a lamp comprising a concave reflector including an opening in the bottom thereof. The reflector is substantially symmetrically arrayed about a longitudinal axis. A light source is positioned in the opening and has a symmetry axis that is coaxial with the longitudinal axis of the reflector. The light source comprises a hollow ceramic member with an inner surface and an outer surface. First and second electrically conductive traces, and first and second rows of first and second electrically conductive pads are formed on the outer surface and connected by the electrically conductive traces to form the necessary circuits. Light emitting diodes are associated with at least some of the electrically conductive pads; and a heat-conducting mechanism is contained within the hollow ceramic member for removing heat generated by the light emitting diodes when the light emitting diodes are operating.

The structure is simple and efficient and very economical to construct.

### BRIEF DESCRIPTION OF THE DRAWINGS

FIG. 1 is a diagrammatic, elevation view of an embodiment of the invention; and

FIG. 2 is an enlarged elevation view, partially in section, of an embodiment of the light source.

### DETAILED DESCRIPTION OF THE INVENTION

For purposes of this application it is to be understood that when an element or layer is referred to as being “on,” “connected to” or “coupled to” another element or layer, it can be directly on, connected to or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. The term “and/or” includes any and all combinations of one or more of the associated listed items.

Although the terms “first,” “second,” “third” etc. may be used to describe various elements, components, regions, layers and/or sections, these elements, components, regions, layers and/or sections are not to be limited by theses terms as they are used only to distinguish one element, component, region, layer or section from another element, component, region, layer or section. Thus, a first element, component, region, layer or section could be termed a second element, component, region, layer or section without departing from the scope and teachings of the present invention.

Spatially relative terms, such as “beneath,” “below,” “upper,” “lower,” “above” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. For example, as used herein, the singular forms “a,” “an” and “the” are intended to include the plural forms as well, unless the context clearly indicates otherwise. It will be further understood that the terms, “comprises” and/or “comprising,” when used in this specification, specify the presence of stated features, integers, steps, operations, elements, and/or components, but do not preclude the presence or addition of one or more other features, steps, operations, elements, components, and/or groups thereof.

For a better understanding of the present invention, together with other and further objects, advantages and capabilities thereof, reference is made to the following disclosure and appended claims taken in conjunction with the above-described drawings.

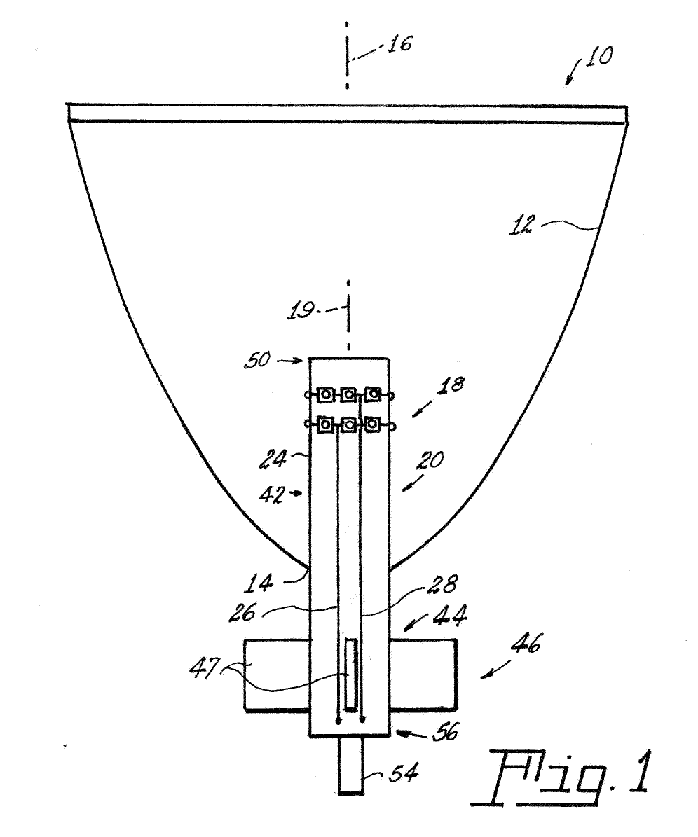

Referring now to the drawings with greater particularity, there is shown in FIG. 1a lamp 10 having a concave reflector 12 including an opening 14 in the bottom thereof. The reflector 12 is substantially symmetrically arrayed about a longitudinal axis 16. While the reflector 12 can be of various configurations, for most applications a simple, smooth parabolic or elliptical surface is preferred. The optical control surface of the reflector 12 may also be segmented to better control the output beam, or textured to mix any color inhomogeneities from individual LEDs. The material for the reflector can be polished metal or an aluminized ceramic or polymer.

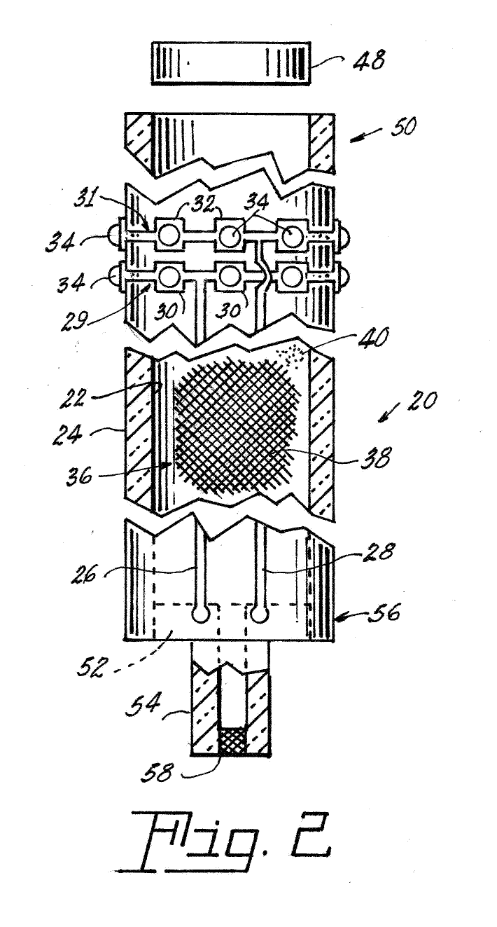

A light source 18 is positioned in the opening 14 and has its symmetry axis 19 coaxial with the longitudinal axis 16 of the reflector. The light source 18 comprises a hollow ceramic member 20 with an inner surface 22 (see FIG. 2) and an outer surface 24. First and second electrically conductive traces 26, 28 are formed on the outer surface 24 and first and second rows 29, 31 of first and second electrically conductive pads 30, 32 are connected by the electrically conductive traces 26, 28. Although the hollow ceramic member 20 is illustrated as being circular in cross-section, it is to be understood that this is exemplary only and other cross-sections such, for example, square or triangular or any other geometric configuration, can be employed if desired. While many materials can be used to form the hollow ceramic member 20, for example, aluminum nitride or polycrystalline alumina, polycrystalline alumina (PCA) is preferred. In a preferred method of making the member 20, particles of alumina are mixed with a volatilizable binder and either extruded or injection molded to form the desired configuration. Alternatively, the ceramic powder could be dry-pressed and sintered. After molding, the member 20 is fired to remove the binder material and form a green substrate. The desired pattern of traces and rows of pads are formed with, preferably, tungsten ink and the green substrate is sintered to form the member 20. In a preferred embodiment the hollow ceramic member 20 is similar in construction to the PCA arc tubes of high-pressure sodium lamps. For example, the member 20 can have an O.D. and I.D. such that: 1 mm≦O.D.≦300 mm with a corresponding 0.5 mm≦I.D.≦298 mm. The ceramic member 20 can have length, L, such that: 10 mm≦L≦500 mm. Preferred values for residential/commercial incandescent replacements may be on the order of O.D.˜10 mm, I.D.˜8 mm, and L˜40 mm such that the length L is at least greater than and preferably substantially greater than the O.D.

It is an advantage of the instant invention that the LEDs are mounted on the lateral, outside surface 24 of the ceramic member 20 and as such the radiant output is directed radially in an approximate Lambertian distribution. Such a radiation pattern puts the majority of the emitted light on the optical control surface of the reflector 12. This permits precise beam control of the output of the reflector with very little glare since no LED is directly emitting along the Z direction, that is, in the direction of the symmetry axis 19.

Light emitting diodes 34 are affixed to the electrically conductive pads 30, 32 in any desired pattern and the necessary electrical connections can be completed by wire-bonding, as is known. Alternatively, packaged LEDs can be used thus eliminating the need for wire-bonding.

To remove the heat generated by the closely packed LEDs a heat-transfer mechanism 36 is contained within the hollow ceramic member 20. The heat-transfer mechanism 36 comprises a small quantity of a volatilizable liquid 40 that can vaporize at the temperatures at which the LEDs operate. A preferred liquid is water. As used herein the term “small quantity” as applied to the volatile liquid means a volume amount that is less than that of the interior volume of the hollow ceramic member 20. In a preferred embodiment of the invention, a ceramic or metallic wick 38 in the form of a fine mesh having, for example a mesh size of about 50 microns is installed within the hollow member 20 and is in substantially contiguous contact with the interior surface 22. When a metallic mesh is employed for the wick 38, preferred materials are nickel or stainless steel. If a ceramic wick is desired it could be made in situ as the hollow ceramic member 20 is pressed and sintered. For proper operation the wick extends at least from the immediate area of the LEDs 34 to some point beyond the area of the LEDs. Preferably, the wick 38 extends for the entire interior length of hollow ceramic member 20.

The light source and electrical traces 26, 28 can be connected via wires to a variable-output, current-regulated power supply to energize the LED's as is known in the art.

In use, the heat transfer mechanism 36 functions as follows: heat generated by operating LEDs 34 raises the temperature of the liquid 40 and turns it into a vapor in the area adjacent the LEDs 34, raising the pressure of the vapor in that area and causing a pressure differential within the hollow ceramic member 20. The vapor moves to a cooler, lower pressure area of the member 20 away from the LEDs where it loses heat by condensing. The heat transfers through the ceramic hollow member 20 to the outside. After condensing, the now liquid water is wicked back by capillary action to the area of the LEDs where the cycle is repeated.

The operation of the heat transfer mechanism was tested in quartz tubing of rectangular cross-section where the vaporization and wicking action could be visually observed.

As will be seen from FIG. 1, the light source 18 has a first section 42 (that contains the LEDs 34) positioned within the reflector 12 and a second section 44 positioned outside of the reflector 12. The second section remains cooler than the first section, which contains the operating LEDs 34, and thus contributes to the cooling of the liquid 40. The second section 44 also can be provided with additional heat dispersers 46, such as fins 47. If necessary, other forms of heat dispersers, such as water-cooling or further air-cooling by the use of fans, can also be used.

The light source 18 is constructed by first forming the hollow ceramic member 20, as described above, including the various traces and pads. After forming, the mesh 38 is rolled and inserted into the hollow center of the member 20 and a seal plug 48 is fitted and sealed, as by a sealing frit, into a first end 50 of the member 20. A second seal plug 52, which includes a tubular capillary 54, is sealed, as by a sealing frit, into a second end 56 of the member 20. The tubular capillary 54 is used, first, to evacuate any contained gaseous matter that may be present from within the hollow center and, second, to dispense the heat conducting liquid 40 into the hollow center, in that order. Evacuation of the member 20 is necessary to prevent the buildup of dangerous pressures in the member 20 when the light source 18 is operating. The end of the capillary is then itself sealed, again by any suitable technique such as a sealing frit or by a suitable plug 58.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A lamp (10) comprising:
a concave reflector (12) including an opening (14) in the bottom thereof and being substantially symmetrically arrayed about a longitudinal axis (16);
a light source (18) with symmetry axis (19) is positioned in said opening (14), said light source symmetry axis (19) being coaxial with said reflector longitudinal axis (16), said light source (18) comprising:
a hollow ceramic member (20) with an inner surface (22) and an outer surface (24);
first and second electrically conductive traces (26, 28) and first and second rows (29, 31) of first and second electrically conductive pads (30, 32) connected by said electrically conductive traces (26, 28) formed on said outer surface (24);
light emitting diodes (34) associated with at least some of said electrically conductive pads (30, 32); and
a heat-conducting mechanism (36) contained within said hollow ceramic member (20) for removing heat generated by said light emitting diodes (34) when said light emitting diodes (34) are operating.

2. The lamp (10) of claim 1 wherein said heat-conducting mechanism (36) comprises a heat-conducting liquid (40).

3. The lamp (10) of claim 2 wherein said heat-conducting mechanism (36) further includes a mesh (38) substantially contiguous with said inner surface (22).

4. The lamp (10) of claim 3 wherein said mesh (38) is selected from ceramic material, nickel and stainless steel.

5. The lamp (10) of claim 2 wherein said heat-conducting liquid (40) is water.

6. The lamp (10) of claim 1 wherein said hollow ceramic member (20) is comprised of polycrystalline alumina.

7. The lamp (10) of claim 1 wherein said light source (18) comprises a first section (42) positioned within said reflector (12) and a second section (44) positioned outside of said reflector (12) and said second section (44) includes heat dispersers (46).

8. The lamp (10) of claim 1 wherein said first and second electrically conductive traces (26, 28) and said electrically conductive pads (30, 32) comprise tungsten ink.

9. A light source (18) comprising:
a hollow ceramic member (20) with an inner surface (22) and an outer surface (24);
first and second electrically conductive traces (26, 28) and first and second rows (29, 31) of electrically conductive pads (30, 32) formed on said outer surface (24) and connected by said electrically conductive traces (26, 28);
light emitting diodes (34) associated with at least some of said electrically conductive pads (30, 32); and
a heat-conducting mechanism (36) contained within said hollow ceramic member (20) for removing heat generated by said light emitting diodes (34) when said light emitting diodes (34) are operating.

10. The light source (18) of claim 9 wherein said heat-conducting mechanism (36) comprises a heat-conducting liquid (40).

11. The light source (18) of claim 10 wherein said heat-conducting mechanism (36) further includes a mesh (38) substantially contiguous with said inner surface (22).

12. The light source (18) of claim 10 wherein said mesh (38) is selected from ceramic materials, nickel and stainless steel.

13. The light source (18) of claim 11 wherein said heat-conducting liquid (40) is water.

14. The light source (18) of claim 9 wherein said hollow ceramic member (20) is comprised of polycrystalline alumina.

15. The light source (18) of claim 9 wherein said light source (18) comprises a first section (42) and a second section (44) and said second section (44) includes heat dispersers (46).

16. The light source (18) of claim 9 wherein said first and second electrically conductive traces (26, 28) and said electrically conductive pads (30, 32) comprise tungsten ink.
